(19) United States
(12) Patent Application Publication
(10) Pub. No.: US 2013/0335211 A1
(43) Pub. Date: Dec. 19, 2013

(54) ELECTRONIC DEVICE

(71) Applicant: Ryosuke Kobayashi, Daito-shi (JP)

(72) Inventor: Ryosuke Kobayashi, Daito-shi (JP)

(73) Assignee: KYOCERA CORPORATION, Kyoto (JP)

(21) Appl. No.: 14/001,493

(22) PCT Filed: Feb. 23, 2012
(86) PCT No.: PCT/JP2012/001236

§ 371 Date: Aug. 23, 2013

(30) Foreign Application Priority Data
Feb. 24, 2011 (JP) 2011038822

(51) Int. Cl. G06F 3/01

(52) U.S. Cl. CPC G06F 3/016
USPC 340/407.2

(57) ABSTRACT

In an electronic device having a touch panel 20, a vibration unit 50 for causing the touch panel 20 to vibrate and an upper housing 10a for covering the upper surface outer edge of the touch panel 20, a visor portion 10a-1 extending inside the top portion of the upper housing 10a is provided, a first elastic member 30 is disposed over the entire circumference of the upper surface outer edge of the touch panel 20, between the upper surface outer edge and the visor portion 10a-1, and a second elastic member 40 is disposed over the entire circumference of the bottom outer edge of the touch panel 20, between the bottom outer edge and a supporting member 10b located thereunder, thereby the panel is not likely to be disturbed and dustproof and waterproof performances are improved.

### CROSS REFERENCE TO RELATED APPLICATION

This application claims priority to and the benefit of Japanese Patent Application No. 2011-038822 filed on Feb. 24, 2011, the entire contents of which are incorporated herein by reference.

### FIELD

The present invention relates to an electronic device that has a panel forming an appearance and causes the panel to vibrate.

### BACKGROUND

Currently, as an input apparatus for electronic devices, touch panels and touch pads are widely used. As such an input apparatus, there is suggested an apparatus that is configured to cause a touch panel or a touch pad to bend and vibrate when the operator operates them, thereby feeding back an operational feeling to the operator's finger and the like (see, for example, Patent Document 1).

### CITATION LIST

Patent Document 1: Japanese Patent Laid-Open No. 2010-044497

### SUMMARY

In the electronic device of Patent Document 1, measures against ingress of dust and water into the device are not taken. Thus, ingress of dust and water from a gap, for example, between a touch panel and a member on which the touch panel is fixed can be considered.

The above-mentioned matter may commonly occur to an electronic device that has a panel forming an appearance and causes the panel to vibrate. Other electronic devices that cause a panel to vibrate include, for example, an electronic device that causes a panel to vibrate by applying a predetermined electrical signal (sound signal) to transmit vibration to a part of the user's body (e.g. the external ear cartilage) contacting with the panel, and thus sound is transmitted to the user. Moreover, other electronic devices that cause a panel to vibrate include an electronic device with a function that vibrates the panel to remove water drops and stains attached thereto.

The present invention provides an electronic device that has a panel forming an appearance and causes the panel to vibrate, in which vibration of the panel is not likely to be disturbed and dustproof and waterproof performances are improved.

That is, the present invention relates to an electronic device including:
a panel;
a vibration unit configured to cause the panel to vibrate; and
a housing configured to cover an upper surface outer edge of the panel, such that
a visor portion extending inwardly over an entire circumference of a top portion of the housing is provided; and
a first elastic member is disposed over the entire circumference of the upper surface outer edge of the panel, between the upper surface outer edge and the visor portion, and a second elastic member is disposed over the entire circumference of an bottom outer edge of the panel, between the bottom outer edge and a supporting member located thereunder.

The present invention enables an electronic device that has a panel forming an appearance and causes the panel to vibrate, in which vibration of the panel is not likely to be disturbed and dustproof and waterproof performances can be improved.

### BRIEF DESCRIPTION OF DRAWINGS

FIG. 1 is a perspective view of an electronic device in accordance with an embodiment of the present invention;

FIG. 2 is an exploded perspective view of the electronic device in accordance with an embodiment of the present invention;

FIG. 3 is a cross-sectional view of the electronic device in accordance with an embodiment of the present invention;

FIG. 4 is a cross-sectional view of the electronic device in accordance with a variation of an embodiment of the present invention;

FIG. 5A is an elevation view of the electronic device in accordance with an embodiment of the present invention;

FIG. 5B is a cross-sectional view taken from line b-b in FIG. 5A; and

FIG. 6 is a cross-sectional view of the electronic device in accordance with a variation of an embodiment of the present invention.

### DESCRIPTION OF EMBODIMENTS

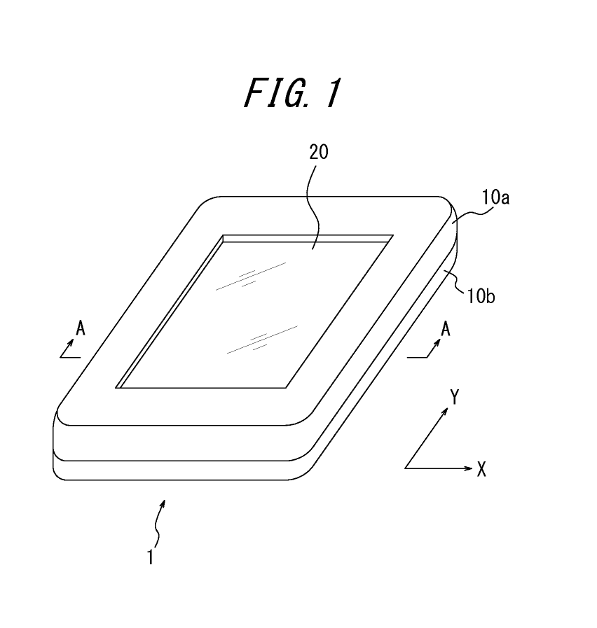

Embodiments of the present invention will now be described with reference to the accompanying drawings. FIG. 1 is a perspective view of the electronic device in accordance with an embodiment of the present invention.

As illustrated in FIG. 1, the electronic device 1 has an upper housing 10a, a lower housing 10b and a touch panel 20 in appearance. The “touch panel” refers to a member disposed on the front surface of a display unit, which may be configured using, for example, an LCD and the like, that is, the touch panel may be a member provided separately from the display unit.

The upper housing 10a and the lower housing 10b form a housing 10 when they are combined into one body. The gap between the upper housing 10a and the lower housing 10b is, when they are combined into one body, sealed by, for example, a rubber packing and the like, and thus an appropriate waterproof/dustproof measure is taken. It is preferable that the upper housing 10a and the lower housing 10b are configured as a case made of, for example, resin, and as such, they are formed by using a material that can withstand a certain level of shock. In the following description, a detailed description of a combined structure of the upper housing 10a and the lower housing 10b is omitted.

The touch panel 20, usually disposed on the front surface of a display unit (not illustrated), detects, on the corresponding touch face of the touch panel 20, a contact of the operator's finger, a stylus pen and the like (hereinafter referred to as merely “a contacting object”) with an object displayed on the display unit. Further, the touch panel 20 detects a position of contact on the touch face and sends the detected contact position to a control unit (not illustrated).

The touch panel 20 may be, for example, configured using a known type such as a resistive type, a capacitive type and an optical type. When contact of the touch panel 20 with a contacting object is detected, physical contact of the contacting object with the touch panel 20 is not essential. For example, when the touch panel 20 is an optical type, the touch panel 20 detects a position where the infrared rays on the touch panel 20 are blocked by the contacting object, and thus contact of the contacting object with the touch panel 20 is not needed.

The above-described display unit displays an object such as a push button switch (push-type button switch) like, for example, a key, as an image. This object is an image that suggests a region to be contacted on the touch face of the touch panel 20 to the operator. Further, the button switch is a button, a key and the like (hereinafter referred to as merely “a key and the like”) used by the operator for input operation. The display unit is configured using, for example, a liquid crystal display panel (LCD), an organic EL display panel and the like.

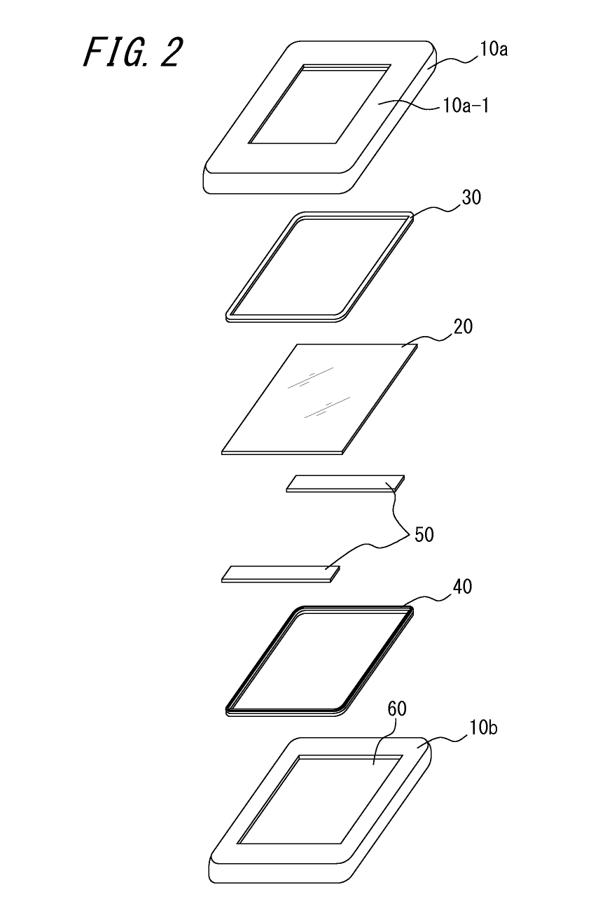

FIG. 2 is an exploded perspective view of the electronic device 1 illustrated in FIG. 1 where the electronic device is broken down into an upper housing 10a, a lower housing 10b, a touch panel 20, a first elastic member 30, a second elastic member 40 and a vibration unit 50.

As illustrated in FIG. 2, the touch panel 20 is configured to be inserted between the upper housing 10a and the lower housing 10b, and the upper surface outer edge of the touch panel 20 is covered by the upper housing 10a. Here, the upper surface outer edge of the touch panel 20 refers to the marginal region of the touch panel 20 on the upper surface thereof and preferably to the region with a width of about 1.0 to 5.0 mm.

Further, the upper housing 10a is, on the top portion thereof, provided with a visor portion 10a-1 extending inwardly. The gap between the visor portion 10a-1 and the upper surface outer edge of the touch panel 20 is provided with a frame-shaped first elastic member 30 over the entire circumference of the upper surface outer edge of the touch panel 20. The first elastic member 30 is described in detail below.

Moreover, the gap between the bottom outer edge of the touch panel 20 and the lower housing 10b is provided with a frame-shaped second elastic member 40 over the entire circumference of the bottom outer edge of the touch panel 20. The second elastic member 40 is also described in detail below. Here, the bottom outer edge of the touch panel 20 refers to the marginal region on the bottom of the touch panel 20, and preferably to the region with a width of about 1.0 to 5.0 mm, as in the case of the first elastic member 30.

Furthermore, on the bottom of the touch panel 20, vibration units 50 are disposed in the vicinity of the upper and lower margins (the far side and this side in the figure) according to the present embodiment. The vibration units 50 may be formed of, for example, a piezoelectric element.

The vibration units 50 may be disposed not only in the vicinity of the upper and lower margins of the touch panel 20, but also in the vicinity of the left and right margins of the touch panel 20.

Moreover, the vibration units 50 generate a vibration according to a predetermined vibration pattern, thereby presenting a tactile sensation to a contacting object being in contact with the touch face. In the present embodiment, the vibration unit 50 generates a vibration based on a drive signal supplied, for example, from a control unit not illustrated.

In addition, a display unit 60 such as an LCD is disposed in a concave portion formed on the lower housing 10b. A base plate not illustrated is disposed on the bottom of the display unit 60.

Next, the internal configuration of the electronic device in accordance with the embodiment of the present invention is described.

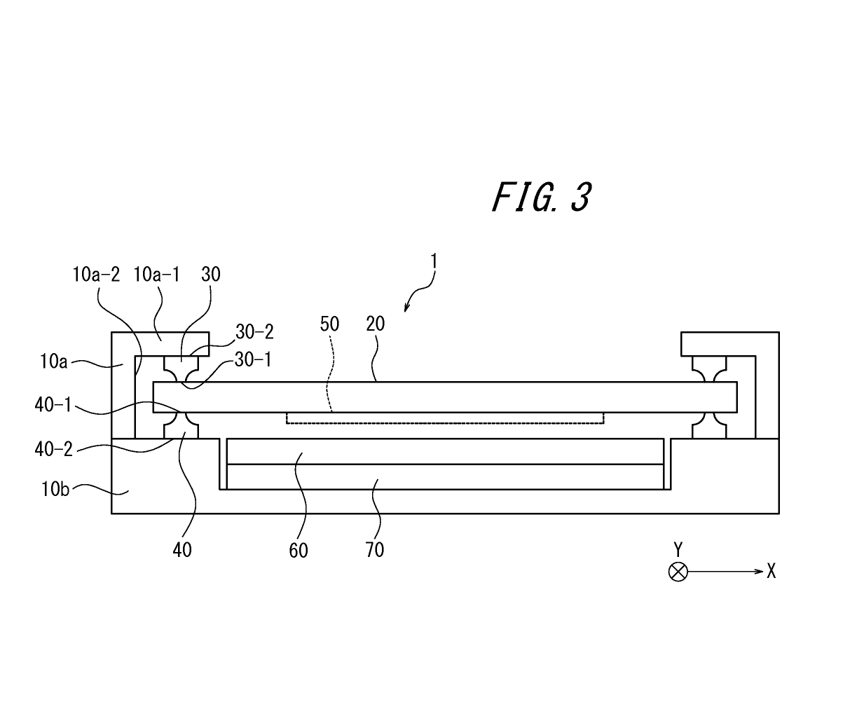

FIG. 3 is a cross-sectional view of the electronic device 1 taken from line A-A in FIG. 1. An example of the electronic device 1 having a symmetric configuration is described below. Thus, in FIG. 3, reference numerals describing the right side configuration of the figure are omitted.

As illustrated in FIG. 3, the touch panel 20 is mounted in the electronic device 1 with the first elastic member 30 disposed between the upper surface outer edge of the touch panel and the visor portion 10a-1 of the upper housing 10a so that the gap between the upper surface outer edge and the visor portion 10a-1 is filled and with the second elastic member 40 disposed between the bottom outer edge of the touch panel 20 and the lower housing 10b.

Thus ingress of the outside air into the device through the gap between the touch panel 20 and the visor portion 10a-1 of the upper housing 10a can be blocked, or sealed, by the first elastic member 30, and thus a waterproof/dustproof measure to the electronic device 1 can be realized. In addition, the first elastic member 30 is made of a material having sufficient waterproof and dustproof performances and an appropriate elasticity, and preferably made of, for example, silicon rubber.

Further, the upper surface outer edge and the bottom outer edge of the touch panel 20 are supported respectively by the first elastic member 30 and the second elastic member 40 in an elastic manner, and thus the touch panel 20 can bend and vibrate while deforming the first elastic member 30 and the second elastic member 40, resulting in less attenuation of the bending vibration thereof.

Moreover, the second elastic member 40 is used for supporting the touch panel, and in the present embodiment, is made of the same material as that used for the first elastic member 30. The second elastic member has a shape of inverted first elastic member 30. Therefore, when the touch panel 20 bends and vibrates, the node of vibration can be held easily in the middle of the visor portion 10a-1 of the upper housing 10a and the lower housing 10b, thereby preventing attenuation of the bending vibration more effectively. In addition, the second elastic member 40 does not need to be disposed continuously, and may be disposed intermittently, over the entire circumference of the bottom outer edge of the touch panel 20. Further, when the second elastic member is disposed continuously over the entire circumference of the bottom outer edge of the touch panel 20, an outside air blocking function is added as in the case of the first elastic member 30.

Furthermore, in the present embodiment, the first elastic member 30 is, in a cross section perpendicular to the longitudinal direction thereof, formed in a substantially inverted convex shape, and on the other hand, the second elastic member 40 is, in a cross section perpendicular to the longitudinal direction thereof, formed in a substantially convex shape. Thus, when the touch panel 20 bends and vibrates, the reaction force from the first elastic member 30 and the second elastic member 40 can be reduced and possible bump of the touch panel 20 against the first elastic member 30 and the second elastic member can be reduced as well. As a result thereof, attenuation of the bending vibration of the touch panel 20 can be further reduced.

Moreover, as in the case of the present invention, the first elastic member 30 and the second elastic member 40 are aligned in the thickness direction (vertical direction in FIG. 3), thereby putting the fulcrum of vibration of the touch panel 20 on the line. That is, lateral vibration of the touch panel 20 can be reduced, and thus the vibration attenuation of the touch panel 20 can be further reduced.

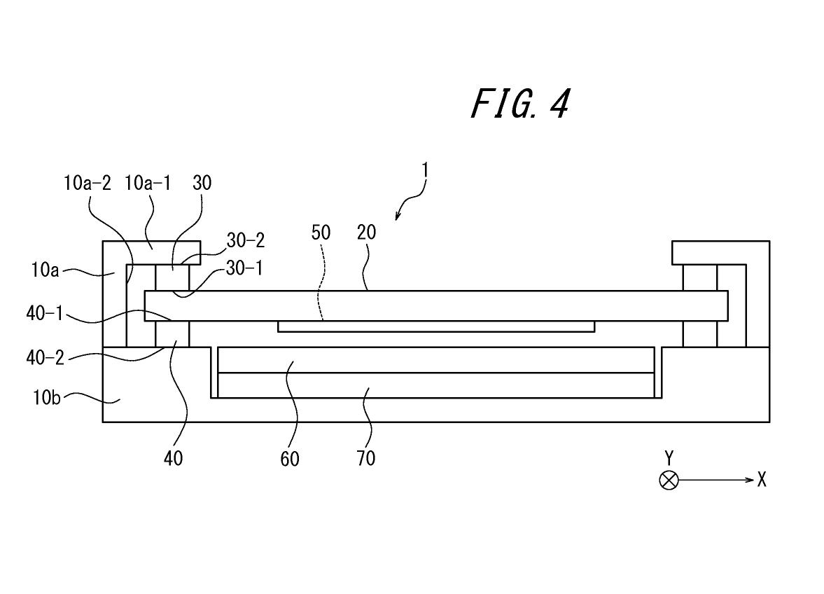

In addition, if the above-mentioned cross-sectional shapes of the first elastic member 30 and the second elastic member 40 are respectively a tapered-shape which is narrower toward the touch panel 20 side, the same effect as that described above can be obtained. However, the cross section does not necessarily have a tapered shape. For example, as illustrated in FIG. 4, the first elastic member 30 and the second elastic member 40 may have a rectangular cross-sectional shape. In addition, if the cross-sectional shape is a tapered shape, the shape is not limited to a substantial convex shape, and may be triangle, semicircular and the like.

The first elastic member 30 is, in the present embodiment, attached to the touch panel 20 and the visor portion 10a-1 respectively at the abutting portion 30-1 abutted against the touch panel 20 and the abutting portion 30-2 abutting against the visor portion 10a-1 of the upper housing 10a with a double-sided tape or adhesive and the like. Further, the second elastic member 40 is, in the present embodiment, as in the case of the first elastic member 30, also attached to the touch panel 20 and the lower housing 10b respectively at the abutting portion 40-1 abutted against the touch panel 20 and the abutting portion 40-2 abutting against the lower housing 10b with a double-sided tape or adhesive and the like. Thus, when the touch panel 20 vibrates, displacement of the touch panel 20 in the XY direction is reduced. In addition, if the abutting portion 30-2 of the first elastic member 30 and the abutting portion 40-2 of the second elastic member 40 are attached respectively to the visor portion 10a-1 of the upper housing 10a and the lower housing 10a in advance, the workability during assembly of the electronic device 1 can be improved.

Moreover, the first elastic member 30 and the second elastic member 40 are not necessarily attached to the visor portion 10a-1, the touch panel 20 and the lower housing 10b as described above, and all of the above-mentioned attachments may be omitted or attachment of merely the abutting portions 30-1 and 40-1 may be omitted by appropriately setting the material and the shape of the first elastic member 30 and the second elastic member 40. In addition, if displacement of the touch panel 20 is a concern, placement of a cushion material between the side wall 10a-2 of the upper housing 10a and the touch panel 20 is effective.

Further, in the present embodiment, the lower housing 10b is equivalent to the supporting member. However, the supporting member is not limited to the lower housing 10b, and for example, a supporting unit extending to the bottom of the touch panel 20 may be provided on the upper housing 10a and this supporting unit may be used as a supporting member. In addition, for example, the width of the concave portion of the lower housing 10b and the display unit 60 may be expanded to use the display unit 60 as a supporting member, or the width of the concave portion of the lower housing 10b and the base plate 70 may be expanded to use the base plate 70 as a supporting member.

Moreover, in the present embodiment, description has been given assuming that, over the entire circumference of the upper surface outer edge of the touch panel 20, the first elastic member 30 is disposed between the upper surface outer edge and the visor portion 10a-1 of the upper housing 10a, to fill the gap between the upper surface outer edge and the visor portion 10a-1. Here, the upper housing 10a may be divided into two, that is, a bezel (frame-shaped member) disposed on the outer edge of the touch panel 20 and the body of the upper housing. When the upper housing is divided into two in this manner, the same effect as that mentioned above can be obtained by disposing the first elastic member 30 between the bezel and the touch panel 20.

According to the electronic device in accordance with the above-described embodiment, use of the first elastic member and the second elastic member may reduce attenuation of bending vibration of the touch panel by the vibration unit and improve a waterproof/dustproof effect on the electronic device.

The present invention is not limited to the above-mentioned embodiments, and various modifications and variations may be made. For example, in the above-described each embodiment, an aspect in which an object is displayed on a display unit (not illustrated) disposed on the bottom of the touch panel and the touch panel detects a contact by the operator has been described. However, the present invention is not limited to such aspect, and for example, an aspect in which no display unit is provided and an object is printed directly on the touch face of the touch panel by ink and the like is also applicable.

Moreover, in the above-mentioned embodiment, description has been made about the case where, by using a touch panel, a contact with the touch face of the touch panel is detected. That is, in the above-described embodiment, the touch panel is considered to be a member such as, a so-called touch sensor. However, the touch panel used for the electronic device according to the present invention may be any member that is in contact with a contacting object such as an operator's finger, a stylus pen and the like.

For example, the touch panel used for the electronic device according to the present invention may be a member such as a mere “panel” that does not detect the position of a contact by a contacting object on the touch face (that is, having no sensing function). In the electronic device configured in such a manner, for example, a press detection unit for detecting a press on the touch panel is provided, thereby determining that the touch panel has been touched based on the press detected by the press detection unit.

Further, in the above-mentioned embodiment, with a touch panel, a contact with the touch face of the touch panel is detected. However, it may be deemed that the press detection unit detects a press on the touch panel, and based on the press, determination may be made that the touch panel has been touched.

The above-described press detection unit detects a press on the touch face of the touch panel, and may be configured by using, for example, any number of strain gauge sensors, piezoelectric elements and the like whose physical or electrical characteristics (strain, resistance, voltage, etc.) vary in response to the press. Further, when the vibration unit is a piezoelectric element, the piezoelectric element may be used as a press detection unit. Strain of the touch panel by a press is detected by employing such configuration, and thus a configuration in which a press on the touch panel is calculated based on the strain is considered.

For example, when the press detection unit is configured by using a piezoelectric element and the like, in the piezoelectric element of the press detection unit, a voltage size (voltage value), which is an electrical characteristic, varies in response to the size of the load (force) (rate of changing the load (force) size (acceleration)) on the press against the touch face of the touch panel. In this case, the press detection unit may notify the control unit of the size of the voltage (voltage value (hereinafter referred to merely “data”)). When the press detection unit notifies the control unit of the data or when the control unit detects the data of the piezoelectric element of the press detection unit, the control unit obtains the data. That is, the control unit obtains the data which is based on a press on the touch face of the touch panel. In other words, the control unit obtains the data based on a press from the press detection unit. In addition, when the data based on a press satisfies a predetermined criterion, the control unit determines that a contact has been made, and can generate a predetermined vibration. Here, the above-mentioned criterion may be appropriately set based on the load characteristics of an intended push button when pushed.

Further, such a press detection unit may be configured based on the contact detection type of the touch panel. For example, in the case of a resistive type, the size of resistance according to the size of contact area is associated with the load (force) of the press against the touch face of the touch panel, thereby forming a press detection unit without using a strain gauge sensor, a piezoelectric element and the like. Alternatively, in the case of a capacitive type, the size of capacitance is associated with the load (force) of the press against the touch face of the touch panel, thereby forming a press detection unit without using a strain gauge sensor, a piezoelectric element and the like.

For such a press detection unit, various configurations may be considered based on the contact detection type of the touch panel. For example, in the case of a resistive type, the size of resistance according to the size of contact area is associated with the load (force) of the press against the touch face of the touch panel, thereby forming a press detection unit without using a strain gauge sensor, a piezoelectric element and the like. Alternatively, in the case of a capacitive type, the size of capacitance is associated with the load (force) of the press against the touch face of the touch panel, thereby forming a press detection unit without using a strain gauge sensor, a piezoelectric element and the like.

In addition, the vibration unit may be formed by using any number of piezoelectric vibrators, by providing a transparent piezoelectric element over the whole surface of the touch panel, or by rotating an eccentric motor once per one cycle of a drive signal. Further, the press detection unit and the vibration unit may, when they are formed by using a piezoelectric element, be formed as a press detection and vibration unit by sharing the piezoelectric element. This is because a piezoelectric element generates a voltage when a pressure is applied and deforms when a voltage is applied.

Moreover, as described above, the vibration unit may also be configured to generate, when the size of voltage (voltage value (data)) of a piezoelectric element serving as a press detection unit satisfies a predetermined criterion, a vibration by driving the piezoelectric element. Here, the point when the size of voltage (voltage value (data)) of a piezoelectric element satisfies a predetermined criterion may be the point when the voltage value (data) reaches a predetermined criterion value, when the voltage value (data) exceeds a predetermined criterion value, or when the voltage value (data) equal to a predetermined criterion value is detected.

The above-described embodiment has been described on the assumption that the touch panel is superimposed on the upper surface of the display unit. It is not essential for the electronic device according to the present invention to be configured in such a manner, and the touch panel and the display unit may be disposed away from each other. However, with a configuration in which the touch panel is superimposed on the upper surface of the display unit, the operator may recognize easier the correspondence relation among an image to be displayed, a region where an operation input is detected and a generating vibration.

In addition, the display unit and the touch panel according to the above-described embodiment may be formed into one apparatus by providing a common base plate having both display unit function and contact detection unit function. Examples of a configuration in which both display unit function and contact detection unit function are integrated include a configuration in which a plurality of photoelectric conversion elements such as photo diodes are mixed regularly into a group of pixel electrodes arranged in a matrix on a liquid crystal panel. The device displays images by a liquid crystal panel structure, and on the other hand, reflects the backlight for the liquid crystal display with a pen tip that touches a desired position on the surface of the panel for input, thereby detecting the position that has been touched, when the reflected light is received by the peripheral photoelectric conversion elements.

The vibration unit may be configured to cause the touch panel to vibrate indirectly by causing the electronic device to vibrate based on the vibration motor (eccentric motor), or may be configured to cause the touch panel to vibrate directly by providing the touch panel with a piezoelectric element.

In addition, in the above-mentioned embodiment, a mobile telephone terminal that has a touch panel with a sensing function and feeds back an operational feeling has been described, however, the present invention is not limited thereto. The electronic device in accordance with the second embodiment of the present invention will now be described below.

For example, the electronic device in accordance with the present invention may be configured to cause the panel to vibrate by applying an electrical signal in response to a predetermined sound signal to the piezoelectric element attached to the panel such as a cover panel for protecting a touch panel and a display unit. In such an electronic device, sound can be transmitted to the user even when a part of the user (e.g. the external ear cartilage) contacts with the panel vibrated.

The mobile telephone 100 described below is provided as an example of an electronic device in accordance with the second embodiment of the present invention, and thus is not limited to the illustrated configuration. The configuration of the mobile telephone 100 may be changed appropriately to the extent that does not cause a problem in applying the present invention.

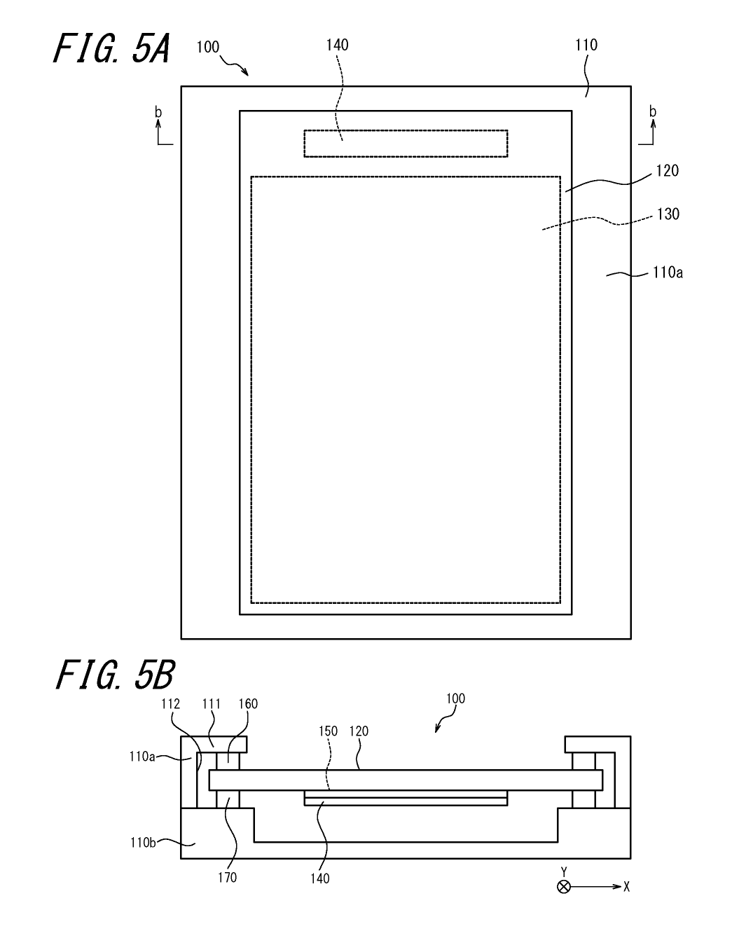

FIGS. 5A and 5B illustrate the electronic device in accordance with the second embodiment of the present invention. FIG. 5A is an elevation view and FIG. 5B is a cross-sectional view taken from line b-b in FIG. 5A.

As illustrated in FIGS. 5A and 5B, the mobile telephone 100, as an electronic device in accordance with the second embodiment of the present invention, has a housing 110, a panel 120, a display unit 130 and a piezoelectric element 140. The piezoelectric element 140 is attached to the panel 120 with a bonding member 150. Each of the panel 120, the display unit 130 and the piezoelectric element 140 is substantially rectangular. The region of the piezoelectric element 140 contacting with the bonding member 150 may be almost whole surface of the main surface on one side of the piezoelectric element. In this case, comparing with the case where, for example, only both ends of the piezoelectric element are the region contacting with the bonding member, the vibration of the piezoelectric element 140 is transmitted more efficiently to the panel 120, and the panel 12 can be bended and vibrated with a enough strength not to cause attenuation even when the panel 120 contacts with a human body.

As illustrated in FIG. 5A, the display unit 130 is disposed almost in the center of the panel 120 in the short direction thereof. The piezoelectric element 140 is disposed, apart from the edge in the longitudinal direction of the panel 120 with a predetermined distance, in the vicinity of the edge, and with the longitudinal direction of the piezoelectric element 140 along the short side of the panel 120. The display unit 130 and the piezoelectric element 140 are disposed side by side, parallel to the internal side face of the panel 120. For example, for the structure in which the panel 120 and the display unit 130 are not superimposed each other, the piezoelectric element 140 may be disposed in the center of the panel 120. When the piezoelectric element 140 is disposed in the center of the panel 120, vibration of the piezoelectric element 140 is transmitted evenly to all over the panel 120, and the user can recognize the sound even if he/she is in contact with various positions of the panel 120 through his/her ear. In addition, as in the case of the above-described embodiment, a plurality of piezoelectric elements may be mounted.

As illustrated in FIGS. 5A and 5B, the housing 110 has an upper housing 110a and a lower housing 110b. The hard portion 110a may be formed of a material such as resin and the like.

The upper housing 110a has a side wall 112 and a visor portion 111 extending in substantially parallel from the upper end of the side wall 112 to the direction of the plane of the panel 120.

In the case of a touch panel, the panel 120 detects that a finger, a pen or a stylus pen is in contact with the touch panel. The detection type of the touch panel may be any type including a capacitive type, a resistive type, a surface acoustic wave type (or an ultrasonic wave type), an infrared type, an electromagnetic induction type and a load detection type. The panel 120 may be a protective panel for protecting the display unit 130. Further, the panel 120 may be made of, for example, a glass or a synthetic resin and may be in the form of a plate.

The display unit 130 is a display device such as a liquid crystal display, an organic EL display or an inorganic EL display.

The piezoelectric element 140 is an element that, upon applying a voltage, expands and contracts according to the electromechanical coupling coefficient of component. The piezoelectric element 140 may be a unimorph, a bimorph or a stacked type piezoelectric element. The stacked type piezoelectric element includes a stacked type bimorph element in which bimorphs are stacked (e.g. 16 or 24 layers are stacked). In the case of a stacked type piezoelectric element, it is configured by, for example, a stack structure of a plurality of dielectric layers of PZT (lead zirconium titanate) and electrode layers disposed between the dielectric layers.

The bonding member 150 may be an adhesive having a thermosetting property and an ultraviolet curable property, a double-side tape and the like. For example, an optically clear resin, which is a clear acrylic ultraviolet cure adhesive may be used.

As illustrated in FIGS. 5A and 5B, a first elastic member 160 is disposed between the upper surface outer edge of the panel 120 and the visor portion 111 of the upper housing 110a to fill the gap therebetween. In addition, a second elastic member 70 is disposed between the bottom outer edge of the panel 120 and the lower housing 110b.

The first elastic member 160 and the second elastic member 170 are, as in the case of the first embodiment, made of a material having waterproof and dustproof performances. The first elastic member 160 and the second elastic member 170 are, for example, silicon rubber. If the first elastic member 160 and the second elastic member 170 have waterproof and dustproof performances, they may be adhesive or double sided tape and the like having the same thermosetting or ultraviolet curable properties as the bonding member 150.

In the above-mentioned mobile telephone 100, as illustrated in FIGS. 5A or 5B, the first elastic member 160 is disposed between the visor portion 111 of the upper housing 110a and the panel 120, and the second elastic member 170 is disposed between the panel 120 and the lower housing 110b. The first elastic member 160 reduces ingress of water and dust into the mobile telephone 100. Moreover, the panel 120 is held inside the housing 110 by the first elastic member 160 and the second elastic member 170, and thus attenuation of vibration of the panel 120 is not likely to occur.

In the mobile telephone 100 having the above-mentioned configuration, sound can be transmitted to the user even when a part of the user's body contacts with the vibrating panel 120, due to expansion and contraction of the piezoelectric element 140.

The piezoelectric element 140 expands and contracts (curves) in the longitudinal direction based on an electrical signal outputted, for example, from the control unit not illustrated. The piezoelectric element 140 is attached to the panel 120 with the bonding member 150, and thus the panel 120 vibrates with expansion and contraction of the piezoelectric element 140. The panel 120 causes not only the region where the piezoelectric element 140 is mounted on but also the region away from the above-mentioned region to vibrate. The panel 120 vibrates, at a certain moment, so that a portion where amplitude of vibration is relatively large and a portion where amplitude of vibration is relatively small are randomly distributed all over the panel. That is, a plurality of wave vibrations are detected all over the panel.

In the above-mentioned mobile telephone 100, a predetermined electrical signal (sound signal) is applied to the piezoelectric element, thereby causing the panel such as a cover panel that protects a touch panel and a display unit to vibrate, and thereby transmitting sound to the user when a part of the user's body (e.g. the external ear cartilage) contacts with the panel that has been vibrated.

The sound outputted by the panel of the above-mentioned mobile telephone 100 may be the voice of a corresponding party or music melody including ringing melody or music. As for the music melody, it may be played based on the music data stored in the internal memory or may be the music data that is stored in the external server and the like and played through the network.

When the sound is outputted based on the vibration of the panel due to expansion and contraction of the piezoelectric element, it often happens that the low-tone range is hard to be heard when compared to the high-tone range. Thus, an amplifier may be controlled so that merely the low-tone range is amplified.

When sound is transmitted to the user through vibration of the panel, if it is not necessary to mount a dynamic speaker separately, an opening (sound emitting port) for sound transmission is not needed to be formed in the housing, and thus the waterproof/dustproof structure of the electronic device can be simplified. A dynamic speaker may be mounted separately. In this case, a sound emitting port of the dynamic speaker may be closed by a waterproof sheet such as, for example, Gore-Tex (™), that passes air but no liquid.

The piezoelectric element causes not only the region of the panel where the piezoelectric element is mounted on but also the region away from the region of the panel where the element is mounted on to vibrate. Thus the user can bring his/her ear into contact with any position on the panel to listen to the sound. Here, a panel having an area larger than the user's ear is adopted, and the user brings his/her ear into contact with the electronic device having a panel of almost the same size as the user's ear or a panel that is larger than the user's ear so that the entire ear can be covered, and thus entry of the surrounding sound (noise) into the ear canal can be reduced and the sound outputted from the electronic device can be heard. On the panel, the region to be vibrated may be larger than a region with a length equivalent to the distance from the helix to the tragus and to the antitragus and the width equivalent to the distance from the crus helicis to the antihelix. The average ear size, for example, of Japanese, can be known with reference to “Japanese body dimension database (1992-1994)” by Research Institute of Human Engineering for Quality Life (HQL). In addition, usually a panel produced with reference to the Japanese ear size may be applicable also to foreigners.

The above-mentioned mobile telephone 100 can transmit sound to the user by vibration through a part of the user's body (e.g. the external ear cartilage), and in comparison with a dynamic speaker, less sound is transmitted around through vibration of the air, thus is suitable for listening, for example, to recorded messages in a train and the like.

Moreover, the above-mentioned mobile telephone 100 transmits sound through vibration of the panel 120, and for example, even if the user wears earphones or headphones, the user can listen to the sound through the earphones or headphones by bringing them into contact with the electronic device.

Further, in the above-mentioned mobile telephone 100, the display unit 130 and the piezoelectric element 140 are disposed in parallel next to each other on the inside face of the panel 120. When the display unit 130 is mounted on the panel 120, the rigidity of the lower portion (the lower side in FIG. 5A) of the panel 120 increases, and thus the upper portion (the upper side in FIG. 5A) of the panel 120 on which the piezoelectric element 140 is attached can be vibrated more than the lower portion of the panel 120. Therefore the vibration of the panel 120 can be transmitted efficiently to the user.

In addition, when the panel vibrating in this manner is contacted with the human body and transmits sound, the voltage applied to the piezoelectric element may be set higher than that applied to the piezoelectric element mounted on a normal, what is called, a panel speaker. This is due to the fact that the supporting structure of the panel to the housing is substantially different. For example, in the case of a panel speaker disclosed in the Japanese Patent Laid-Open No. 2010-114866, the panel itself does not deform significantly, and is supported by the housing at the longitudinal ends thereof, with a film member, an expandable rubber material, a spring member and the like so that the whole panel will move as a unit in the panel thickness direction. On the other hand, in the above-mentioned mobile telephone 100, the whole periphery of the panel 120 is attached to the housing 110 by the first elastic member 160 and the second elastic member 170 and supported thereby. That is, the panel 120 of the mobile telephone 100 is, compared to the panel of the panel speaker described in the above-mentioned document, tightly fixed to the housing. In other words, for the first elastic member 160 and the second elastic member 170 that support the whole periphery of the panel 120, in comparison with a film member, an expandable rubber member and a spring member and the like that hold a so-called panel speaker, as mentioned above, there is selected a material with an elasticity to allow the panel to vibrate so that a portion where amplitude of vibration is relatively large and a portion where amplitude of vibration is relatively small are randomly distributed over the panel. Thus the voltage applied to the piezoelectric element 140 of the mobile telephone 100 is larger than that usually applied to the piezoelectric element mounted on a so-called panel speaker.

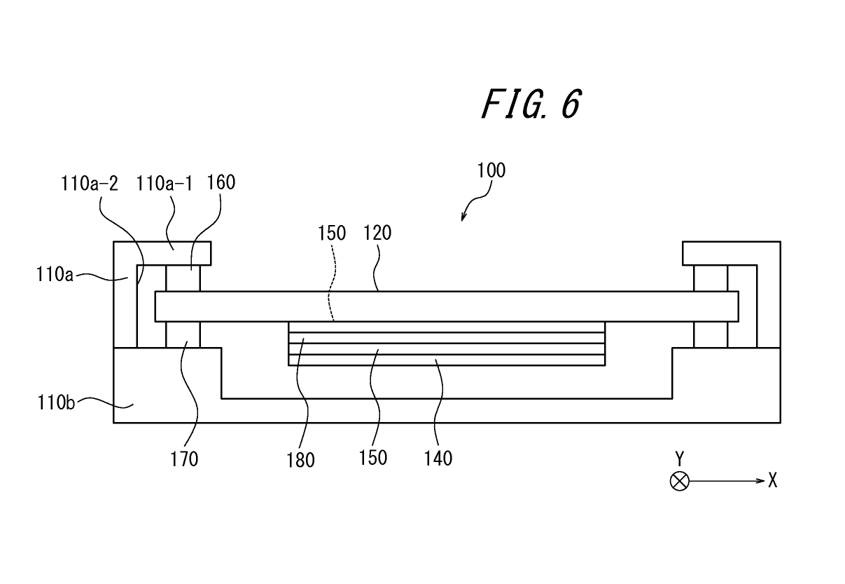

The mobile telephone 100 has been described above. The mobile telephone 100 is not limited to the above-described configuration, and various modifications are available for configuration. FIG. 6 is a view illustrating a modified example of the electronic device in accordance with the second embodiment of the present invention. FIG. 6 is a cross-sectional view seeing from the same direction as that of FIG. 5B.

As shown in FIG. 6, an intermediate member 180 may be disposed between the piezoelectric element 140 and the panel 120. In this case, the piezoelectric element 140 and the intermediate member 180 may be bonded by the bonding member 150 and further, the intermediate member 180 and the panel 120 may be bonded by the bonding member 150. The bonding member 150 may be the above-mentioned adhesive or double-sided tape.

The intermediate member 180 is, for example, a resin plate, a plate or a resin plate containing glass fiber. The intermediate member 180 is disposed between the piezoelectric element 140 and the panel 120, thereby, for example, when an external force is applied to the panel 120, reducing the probability of damaging the piezoelectric element by the external force being transmitted to the piezoelectric element. Further, disposal of the intermediate member 180 between the piezoelectric element 140 and the panel 120 may reduce the resonance frequency of the panel 120 and improve the acoustic property of low-frequency band. In addition, instead of the intermediate member 180, a disc-shaped weight may be attached to the piezoelectric element 140 with the bonding member 150. Thus, attenuation of the panel vibration is not likely to occur even if the human body contacts with the panel hardly.

Further, in the above-mentioned mobile telephone 100, the piezoelectric element is attached to the panel. However, it may be attached to other places. For example, the piezoelectric element may be attached to a battery lid covering a battery. The battery lid is usually attached to a face that differs from a panel in the mobile telephone, and in such a configuration, the user may listen to the sound by bringing a part of his/her body (e.g. ear) into contact with the face that differs from the panel.

The above-mentioned electronic device for transmitting sound to the user through a part of the user's body (e.g. the external ear cartilage) may be an electronic device that transmits both the sound transmitted through a part of the user's body contacting with a vibrating panel (sound conducted through the human body) and the air vibration near the panel caused by the vibration of the panel (air-conducted sound).

A plurality of embodiments of the present invention have been described above, and it is obvious that each configuration of the embodiments may appropriately be combined.

### REFERENCE SIGNS LIST

1 electronic device
10a upper housing
10b lower housing
10a-1 visor portion
10a-b side wall
20 touch panel
30 first elastic member
30-1, 30-2 abutting portion
40 second elastic member
40-1, 40-2 abutting portion
50 vibration unit
60 display unit
70 base plate
100 mobile telephone
110 housing
110a upper housing
110b lower housing
111 visor portion
112 side wall
120 panel
130 display unit
140 piezoelectric element
150 bonding member
160 first elastic member
170 second elastic member
180 intermediate member

1. An electronic device comprising:
a panel;
a vibration unit configured to cause the panel to vibrate; and
a housing configured to cover an upper surface outer edge of the panel, wherein
a visor portion extending inwardly over an entire circumference of a top portion of the housing is provided; and
a first elastic member is disposed over the entire circumference of the upper surface outer edge of the panel, between the upper surface outer edge and the visor portion, and a second elastic member is disposed over the entire circumference of a bottom outer edge of the panel, between the bottom outer edge and a supporting member located thereunder.

2. The electronic device according to claim 1 wherein the panel is as large as to cover an entire ear of a user.
